(19) United States
(12) Patent Application Publication
(10) Pub. No.: US 2015/0136661 A1
(43) Pub. Date: May 21, 2015

(54) METHOD AND SYSTEM FOR PROCESSING LOW GRADE SHREDDER RESIDUE FINES

(71) Applicant: Thomas Valerio, Atlanta, GA (US)

(72) Inventor: Thomas Valerio, Atlanta, GA (US)

(21) Appl. No.: 14/523,500

(22) Filed: Oct. 24, 2014

Related U.S. Application Data
(60) Provisional application No. 61/895,791, filed on Oct. 25, 2013.
(60) Provisional application No. 61/943,589, filed on Feb. 24, 2014.

(51) Int. Cl. B07B 9/02; B07B 4/08

(52) U.S. Cl. CPC B07B 9/02; B07B 4/08
USPC 209/2; 209/422; 209/44; 209/3

(57) ABSTRACT

Processing shredder residue fines to recover valuable metals, such as copper, from waste materials. The disclosed systems and methods employ processes that further refine the waste materials to concentrate the metallic material after the waste materials are initially processed. Processes include employing a destoner, and optionally multiple destoners and screens, to concentrate metal constituents in the shredder residue fines.

### CROSS-REFERENCE TO RELATED APPLICATIONS

The present application claims priority under 35 U.S.C. Section 119(e) to U.S. Provisional Patent Application No. 61/895,791, filed Oct. 25, 2013, and titled “Method And System For Processing Low Grade ASR Fines” and to U.S. Provisional Patent Application No. 61/943,589, filed Feb. 24, 2014, and titled “Method And System For Processing Low Grade ASR Fines,” the entire contents of which are incorporated herein by reference.

### FIELD OF THE INVENTION

This invention relates to systems and methods for recovering metals (ferrous and non-ferrous) from recycled materials. More particularly, this invention relates to systems and methods for recovering metals from automobile shredder residue (ASR) and other shredder residue. Even more specifically, this invention relates to systems and methods for recovering metals from low grade metal shredder residue fines where low grade metal is intended as a shredder residue with a low content of metals (indicatively less than 15 percent) and fines is intended as the smallest fraction of the shredder residue (indicatively below 20 millimeters).

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances characterized by the fact that a majority of the material (typically over 65%) is made of ferrous metal. For examples, at the end of its useful life, an automobile is shredded. This shredded material is processed (by one or more large drum magnets) to recover most of the ferrous metal contained in the shredded material. The remaining materials, referred to as automobile shredder residue, or ASR, may still include ferrous and non-ferrous metals, including copper wire and other recyclable materials. ASR is mainly made of non-metallic material (dirt, dust, plastic, rubber, wood, foam, et cetera), non-ferrous metals (mainly aluminum but also brass, zinc, stainless steel, lead, and copper) and some remaining ferrous metal that was not recovered by the first main ferrous recovery process (that is, the drum magnets). Similar efforts have been made to recover materials from whitegood shredder residue (WSR), which are the waste materials left over after recovering most of the ferrous metals from shredded machinery or large appliances.

The ASR and WSR resulting from the recovery of much of the ferrous metal in the waste stream are referred to as “virgin” ASR (or virgin WSR). Usually, this virgin ASR or WSR is further processed to recover certain metal and non-metal materials. The waste stream that remains after this further processing is referred to as “waste” ASR (or waste WSR). Virgin ASR typically contains less than 15 percent metals while waste ASR typically contains less than 5 percent metal content.

L. Fabrizi et al. provides a characterization of typical virgin ASR. ASR includes 23 percent elastomers; 13 percent glass and ceramics; 13 percent chlorine free thermosets and form parts; 13 percent iron; 7 percent foam material; 6 percent polyvinyl chloride (PVC); 6 percent other fibers and cover-materials; 5 percent other components; 4 percent wood, paper, and cardboard; 3 percent aluminum; 3 percent other thermosets; 3 percent paint; and 1 percent copper. See L. Fabrizi et al., Wire Separation from Automobile Shredder Residue, PHYSICAL SEPARATION IN SCIENCE AND ENGINEERING, Vol. 12, No. 3, pp. 145-165 (2003). In addition to the diversity of the nature of the materials in ASR, the materials are present in ASR in different shapes and sizes. The large differences in sizes is explained by the size of the shredders used in the ASR industry and explained by the size of the rack pieces (cars, trucks, etc.) that enter the shredders, which is unique to ASR as compared to other waste materials. The diversity of material shapes is explained in part by the varying nature of the material. WSR is characterized by a similarly diverse collection of materials and material sizes and shapes. Again, this diversity is explained by the diverse nature of components that make up the underlying product that enters the shredders and the nature of the shredders themselves.

This combination of diverse materials and diverse material size and shape provides a unique challenge in separating and recycling specific materials in an efficient manner. The ability to efficiently separate and concentrate recyclable materials reduces the negative environmental impact of these materials, as less of this residue will be disposed of in landfills.

ASR and WSR material contains some “fines.” These fines consist of material primarily smaller than 20 millimeters. Also, these fines are “low grade,” that is, the fines contain less than fifteen (15) percent metal. Because of the limited performance of the state of the art ferrous and non-ferrous metals recovery technologies used for ASR and WSR fines, the fines are either 1) disposed directly in a landfill when the process for recovering some of the metals they contain is considered economically not convenient or, 2) processed by those ferrous and non-ferrous metal recovery technologies but the processed residue still contains some valuable ferrous and non-ferrous metals constituting a lower grade metal ASR fines that is then disposed in a landfill, negatively impacting the environment. However, if additional metals could be recovered from the low grade shredder residue fines, then less material would be disposed of in landfills and the overall ASR and WSR processing would have increased economic viability, which would encourage such processing and, again, reduce the amount of waste material disposed of in landfills. Additionally, the recovered and recycled metals would contribute to saving natural resources of metal deposits.

In view of the foregoing, a need exists for cost-effective, efficient methods and systems for recovering additional metals from low grade shredder residue fines, where the process results in a high concentration of recovered metals.

### SUMMARY OF THE INVENTION

The present invention provides cost-effective, efficient methods and systems for recovering metals from low grade metal shredder residue fines, such as materials seen in a recycling process, including ferrous and non-ferrous metals, in a manner that facilitates revenue recovery while also reducing landfill.

One aspect of the present invention provides, a method for recovering metal from low grade shredder residue fines including the steps of: receiving a material comprising low grade shredder residue fines, wherein the low grade shredder residue fines comprises virgin shredder residue fines or waste shredder residue fines; processing the received material in a first destoner to produce a first heavy fraction and a first light fraction of the material; and collecting concentrated metals based on the first heavy fraction, wherein the concentrated metals has a concentration of metal constituents greater than the concentration of metal constituents in the received material.

In another example embodiment, a method for recovering metal from low grade shredder residue fines comprising the steps of: receiving a material comprising low grade shredder residue fines; drying the received material to produce a dried material; processing the dried material in a first destoner to produce a first heavy fraction and a first light fraction of the material; and collecting concentrated metals based on the first heavy fraction, wherein the concentrated metals has a concentration of metal constituents greater than the concentration of metal constituents in the received material.

In yet another example embodiment, a system for recovering metal from low grade shredder residue fines includes a dryer to produce a dried material from a received material by reducing moisture content of the received material, the received material comprising low grade shredder residue fines, wherein the low grade shredder residue fines comprises virgin shredder residue fines or waste shredder residue fines. The system further includes a first destoner to produce a first heavy fraction and a first light fraction of the dried material such that the heavy fraction comprises ferrous and non-ferrous metals. The system also includes a screen to segregate the first heavy fraction by size into multiple size ranges of the first heavy fraction.

### BRIEF DESCRIPTION OF THE DRAWINGS

FIG. 1 depicts a process flow diagram for processing recycled materials in accordance with an exemplary embodiment of the present invention.

FIG. 2 depicts a process flow diagram for processing recycled materials in accordance with another exemplary embodiment of the present invention.

FIG. 3 depicts a process flow diagram for processing recycled materials incorporating a dryer in accordance with another exemplary embodiment of the present invention.

FIG. 4 depicts a system for processing recycled materials in accordance with an exemplary embodiment of the present invention.

### DETAILED DESCRIPTION OF THE EXEMPLARY EMBODIMENTS

Exemplary embodiments of the present invention provide systems and methods for recovering ferrous and non-ferrous metals, such as aluminum and copper, employing a primarily dry process and in a highly concentrated form.

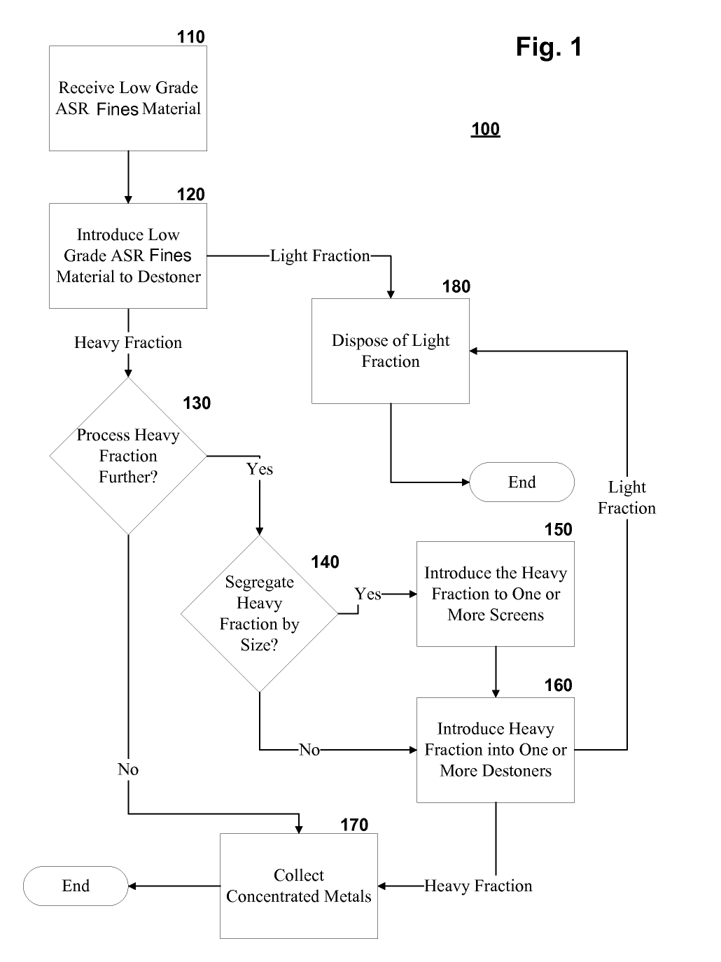

FIG. 1 depicts a process 100 for recovering metals from low grade shredder residue fines in accordance with an exemplary embodiment of the present invention. Referring to FIG. 1, at step 110, the process 100 begins by receiving low grade shredder residue fines. These shredder residue fines may be virgin shredder residue fines, which result from the initial processing of a shredded automobile or other whitegood or piece of heavy equipment. The initial processing of the shredded automobile or other whitegood or piece of heavy equipment removes ferrous metal from the shredded material. Alternatively, these shredder residue fines result from the further processing of ASR or WSR. This further processing recovers certain metals from the ASR and WSR, forming waste ASR and WSR. Thus, the low grade shredder residue fines may consist of virgin shredder residue fines or waste shredder residue fines. For the present invention, both the virgin shredder residue fines and the waste shredder residue fines are low grade fines, with less than fifteen percent (15%) metal content and perhaps as low as five percent (5%) metal content for waste ASR and WSR. The fines are less than about 20 millimeters in size.

Although ASR and WSR are mentioned as separate types of shredder residue, it is also possible that the low grade fines are produced by a process that shreds both automobiles and whitegoods and other heavy equipment, thus resulting in a combined ASR and WSR. The present invention is directed to any of this shredder residue and is not limited to only ASR or WSR.

At step 120, the low grade shredder residue fines are introduced onto a destoner, which is a type of gravity separation table used to separate granular material by density. A destoner includes a vibrating, screen covered deck which is positioned on an incline, such that the deck slopes down in one direction. Granular material, such as the low grade shredder residue fines, is introduced onto the deck as it vibrates. The screen allows air to flow up from beneath the deck, but the screening opening is small enough that prevents material from going through the deck, so all of the material stays on top of the deck. This air flow causes light components of the low grade shredder residue fines to float over the surface of the deck in a stratified mass. The heavier components remain close to or on the deck. The vibration and air flow actions cause the lighter strata to move down the inclined deck while the heavy strata move up the incline. In this way, a heavy fraction of the material can be collected at the upper end of the inclined deck while a light fraction can be collected at the lower end of the inclined deck. The heavy fraction includes metals, rocks, and glass, while the light fraction includes dirt, dust, foam, fabric, plastic, rubber, and wood.

The destoner may be a pressure-type or vacuum-type design. A pressure-type destoner pushes air up through the screen of the deck, creating a positive pressure over the deck. This is accomplished by positioning a fan under the deck structure of the destoner. Typically, the pressure-type destoner has an open deck. A vacuum-type destoner creates a vacuum over the deck, creating a suction that pulls air through the screen of the deck. A vacuum-type destoner is sealed instead of open, with an air source downstream of the destoner deck. Multiple destoners, in parallel, may be employed at step 110.

The material received at step 110 may be transported to the destoner at step 120 using a conveyor system, screw auger, or other known dry material conveyance system. The material may be added to a hopper which then introduces material into the destoner.

At step 130, the process 100 may optionally include deciding whether the heavy fraction resulting from step 120 is to be further processed. If this heavy fraction is not to be further processed, then the concentrated metals in the form of the heavy fraction are collected at step 170 and process 100 ends. If this heavy fraction is to be further processed, then the process 100 moves to step 140. At step 140, a decision is made on whether to segregate the heavy fraction by size.

If the heavy fraction resulting from step 120 is to be segregated by size, then the process 100 moves to step 150, where the heavy fraction is introduced into one or more screens in a series. These screens segregate the material by size. For example, exemplary screen sizes are 1) less than 1.5 millimeters; 2) from 1.5 millimeters to 3 millimeters; 3) from 3 millimeters to 6 millimeters; 4) from 6 millimeters to 12 millimeters, and 5) from 12 millimeters to 20 millimeters. Of course, other size ranges and numbers of screens can be used, such as 1) less than 1.5 millimeters; 2) from 1.5 millimeters to 2.3 millimeters; 3) from 2.3 millimeters to 3.5 millimeters, and over 3.5 millimeters. The segregated material from step 150 is then introduced into one or more destoners at step 160. For example, each size range of material may be sent to a separate destoner to be processed in parallel. Alternatively, each size range of material may be sent batch-wise to the same destoner. In yet another alternative embodiment, material with a size of 6 mm or less (or 3.5 mm or less) is processed in one or more destoners at step 160 while larger material is not processed at step 160. Instead, this material may be processed with other equipment or size-reduced and reintroduced into the process at step 150.

The light fraction resulting from step 160 is waste and is disposed of or otherwise collected in step 180. Alternatively, the light fraction resulting from step 160 is rerun at step 160.

If the heavy fraction resulting from step 120 is not to be segregated by size, then the process 100 moves to step 160, where the heavy fraction is then introduced into one or more destoners. If multiple destoners are used at step 160, they may be used in series or parallel. If used in series, the heavy fraction from one destoner is introduced into the next destoner.

At step 170, the concentrated metal is collected. This concentrated metal is the heavy fraction from the destoners, either at the end of step 130 or the end of step 160. The metal concentration in the material at step 170 will be approximately 2 to 7 times greater than the metal concentration in the low grade shredder residue received at step 110 for each destoner step.

If the ASR fines are virgin ASR, then the concentrated metal will be predominantly iron and aluminum. If the ASR fines were previously processed to recover ferrous and non-ferrous metals, the concentrated metal will be predominantly copper.

Material may be transported from one destoner to a second destoner or to and from screens using a conveyer system or other known technique for moving dry material.

The light fractions recovered from the destoners at steps 120 and step 160 are disposed of as waste material from the process at step 180.

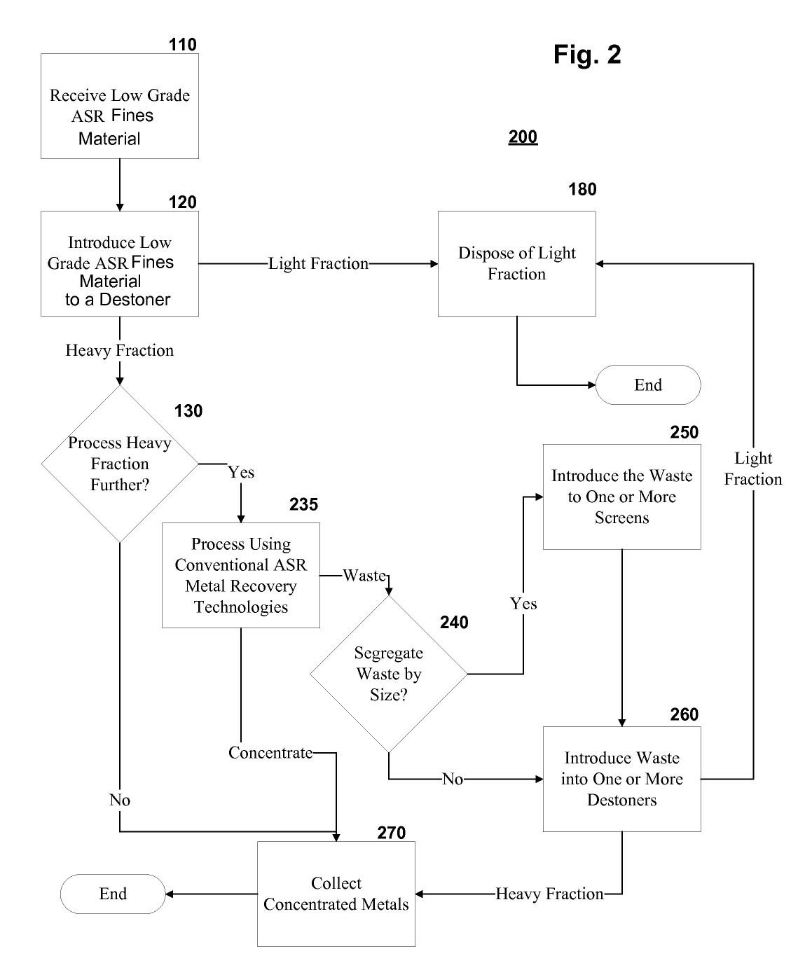

FIG. 2 depicts a process flow diagram 200 for processing recycled materials in accordance with another exemplary embodiment of the present invention. Referring to FIGS. 1 and 2, the process 200 includes the identical steps 110, 120, and 130 as process 100 depicted in FIG. 1 (see description of these steps above). However, following step 130, process 200 moves to step 235, were the heavy fraction from step 120 is further processed using conventional ASR metal recovery technologies. For example, such technologies are described in U.S. Pat. Nos. 7,674,994; 7,658,291; 7,732,726; 7,786,401; 8,138,437; 8,158,902; 8,360,242; and 8,360,347. Such technologies are also described in U.S. patent application Ser. Nos. 12/917,159 (published as U.S. Patent Pub. 2011/0147501) and 13/616,948 (published as U.S. Patent Pub. 2013/0008832). The entire disclosures of these listed patents and patent applications are incorporated by reference herein. Other examples include processing with eddy current technology and magnetic-based ferrous metal separators, such as by equipment available from SGM Magnetics Corporation.

The result of applying these conventional technologies is a metal concentrate product and a waste shredder residue product. The metal concentrate is collected at step 270. At step 240, the process 200 may optionally include the step of segregating the waste shredder residue by size.

If the waste shredder residue resulting from step 235 is to be segregated by size, then the process 200 moves to step 250, where the heavy fraction is introduced into one or more screens in a series. These screens segregate the material by size. For example, exemplary screen sizes are 1) less than 1.5 millimeters; 2) from 1.5 millimeters to 3 millimeters; 3) from 3 millimeters to 6 millimeters; 4) from 6 millimeters to 12 millimeters, and 5) from 12 millimeters to 20 millimeters. Of course, other size ranges and numbers of screens can be used, such as 1) less than 1.5 millimeters; 2) from 1.5 millimeters to 2.3 millimeters; 3) from 2.3 millimeters to 3.5 millimeters, and over 3.5 millimeters. The segregated material is then introduced into one or more destoners at step 260. For example, each size range of material may be sent to a separate destoner to be processed in parallel. Alternatively, each size range of material may be sent batch-wise to the same destoner. In yet another alternative embodiment, material with a size of 6 mm or less (or 3.5 mm or less) is processed in one or more destoners at step 260 while larger material is not processed at step 260. Instead, this material may be processed with other equipment or size-reduced and reintroduced into the process at step 250.

If the waste shredder residue resulting from step 235 is not to be segregated by size, then the process 200 moves directly to step 260, where the waste shredder residue is introduced into one or more destoners. If multiple destoners are used at step 260, they may be used in series or parallel. If used in series, the waste shredder residue from one destoner is introduced into the next destoner.

At step 270, the concentrated metal is collected. This concentrated metal is the heavy fraction from the destoners, either at the end of step 130 or the end of step 260. The metal concentration in the material at step 270 will be approximately 2 to 7 times greater than the metal concentration in the low grade shredder residue received at step 110 for each destoner step.

This alternative process 200 may be preferable for virgin shredder residue received at step 110, but the process 200 is not limited to virgin shredder residue. Similarly, the process 100 is not limited to waste shredder residue received at step 110.

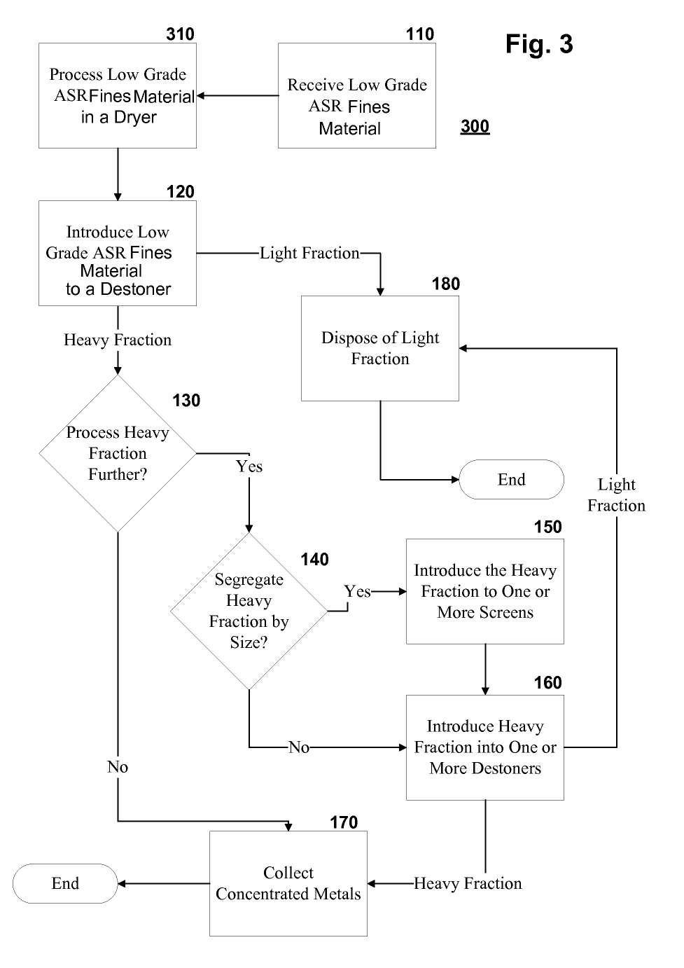

FIG. 3 depicts an alternative process flow diagram 300 for processing recycled materials incorporating a dryer in accordance with an exemplary embodiment of the present invention. Referring to FIGS. 1 and 3, FIG. 3 is identical to FIG. 1, except for the addition of step 310. At step 310, the low grade ASR fines material received at step 110 is processed in a dryer. Typically low grade ASR material has moisture content between 15 percent and 35 percent, depending on the weather conditions of the location where the ASR material was produced or stored. The use of a dryer at step 310 may reduce the average moisture content to below 10 percent. This reduction in the moisture content of the ASR will improve the separation of the ASR material at step 130. Dirt, dust, foam, fabric, and wood components will have less moisture and, accordingly, less weight, making it more likely that these materials will end up in the light fraction generated at step 130.

One possible dryer to be used at step 310 is rotary drum dryer. Typically, a rotary drum dryer includes a drum connected to a drive mechanism that rotates the drum, a burner that produces hot air, a raw material feed system, lifting blades placed inside the drum. The heated air is introduced into the drum as it rotates. The lifting blades move the material in the drum, exposing the entire volume of material to the heated air. The residence time in the rotary drum can be adjusted for the moisture content of the incoming feed and the ambient temperature to arrive at the desired moisture content of the ASR material to be fed into the destoner at step 130.

As indicated above, FIG. 3 is a modification of FIG. 1, with the addition of a drying step at step 310 of process 300 prior to processing the ASR material at step 130. The process 200 depicted in FIG. 2 can similarly be modified to add a drying step. In this case, a drying step would again be added between steps 110 and 120 in process 200 to reduce the moisture content of the dirt, dust, foam, fabric, and wood components of the ASR material. Reducing the moisture content of these materials increases the likelihood that the dirt, dust, foam, fabric, and wood components of the ASR material ends up in the light fraction at step 130.

One possibility of dryer is rotary drum dryer like the ones used for drying sand consisting mainly a rotary drum, a burner producing hot air, a raw material feeding system, lifting blades placed inside the drum to carry forward and moving the material with material and hot air introduced on one end of the drum. Based on moisture content of the infeed material, air temperature and residence time of the material in the drum, material is dried up.

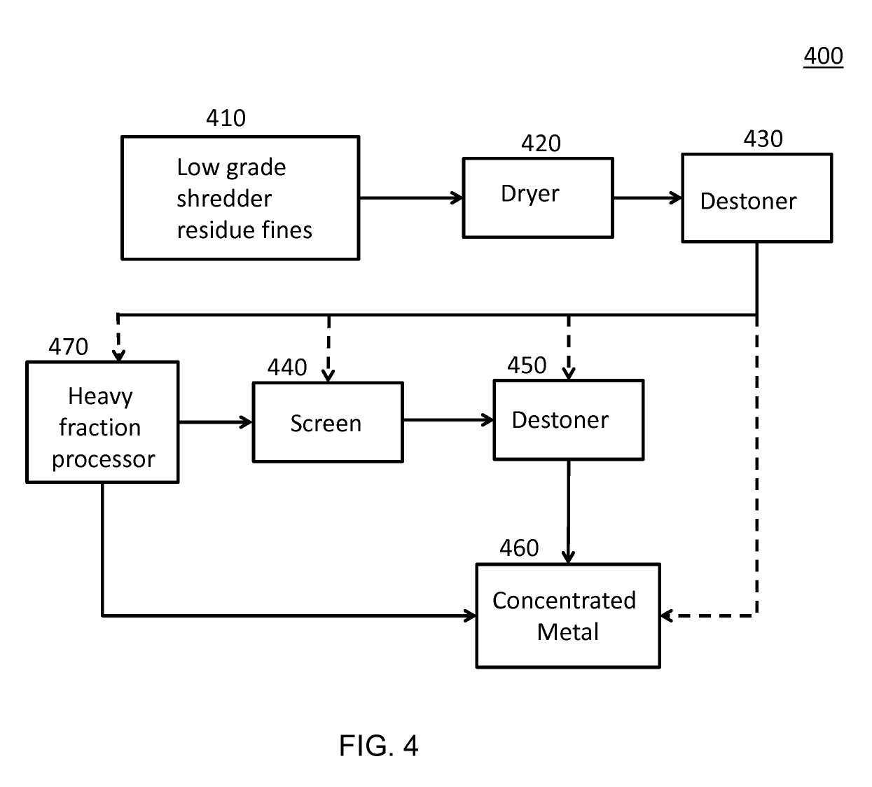

FIG. 4 depicts a system 400 for recovering metals from low grade shredder residue fines in accordance with an exemplary embodiment of the present invention. The system 400 may be used to implement the processes 100, 200, and 300 of FIGS. 1, 2, and 3, respectively. Referring to FIGS. 1-4, the system 400 includes a source of low grade shredder residue fines 410. The low grade shredder residue fines 410 corresponds to the low grade shredder residue fines described with respect to FIGS. 1-3.

The system 400 may also include one or more dryers 420. The low grade shredder residue fines received at step 110 of FIGS. 1-3 may be processed in the dryer 420. For example, typically, low grade ASR material (i.e., low grade ASR fines) has moisture content between 15 percent and 35 percent, depending on the weather conditions of the location where the ASR material was produced or stored. The use of the dryer 420 at step 310 may reduce the average moisture content to below 10 percent. The reduction in the moisture content of the low grade ASR material can improve the separation of the ASR material at step 130 of FIGS. 1-3. Dirt, dust, foam, fabric, and wood components will have less moisture and, accordingly, less weight, making it more likely that these materials will end up in the light fraction generated at step 130.

In some example embodiments, the dryer 420 may be a rotary drum dryer as described above with respect to FIG. 3. To illustrate, the dryer 420 may be a rotary drum dryer similar to dryers used for drying sand, where the dryer 420 includes a rotary drum, a burner producing hot air, a raw material feeding system, lifting blades placed inside the drum to carry forward and moving the material with material and hot air introduced on one end of the drum. In some example embodiments, the dryer 420 may be omitted from the system 400.

The system 400 may also include one or more destoners 430. For example, at step 120 of FIGS. 1-3, the low grade shredder residue fines are introduced onto the destoner 430, which is a type of gravity separation table used to separate granular material by density as described above. The destoner 430 may be a pressure-type or vacuum-type design. In some example embodiments, the one or more destoners 430 include multiple destoners that are arranged in parallel or in series. The destoner 430 produces a heavy fraction and a light fraction of the material (i.e., the material being the low grade shredder residue fines) that has been dried by the dryer 420. Alternatively, when the dryer 420 omitted or not used, the destoner 430 produces a heavy fraction and a light fraction of the material from the source of the low grade shredder residue fines 410. The heavy fraction may include metals, rocks, and glass, while the light fraction may include dirt, dust, foam, fabric, plastic, rubber, and wood.

The heavy fraction produced by the destoner 430 may be transferred to a concentrated metal container 460. Alternatively, the system 400 may include one or more screens 440 for segregating the heavy fraction by size as described with respect to FIGS. 1 and 3. For example, if the heavy fraction resulting from step 120 of FIGS. 1 and 3 is to be segregated by size, then the heavy fraction from the destoner 430 may be introduced into the screens 440. The screens 440 may have different sizes as described above with respect to step 150 and may segregate the heavy fraction by size. In some example embodiments, the heavy fraction from the destoner 430 may not be segregated by size and may instead be provided to the second destoner 450.

In some example embodiments, the heavy fraction produced by the destoner 430 may be transferred to a heavy fraction processor 470 for further processing using, for example, conventional ASR metal recovery technologies. For example, step 235 of FIG. 2 may be implemented using heavy fraction processor 470. Example conventional ASR metal recovery technologies are described in U.S. Pat. Nos. 7,674,994; 7,658,291; 7,732,726; 7,786,401; 8,138,437; 8,158,902; 8,360,242; 8,360,347; and U.S. patent application Ser. Nos. 12/917,159 (published as U.S. Patent Pub. 2011/0147501) and 13/616,948 (published as U.S. Patent Pub. 2013/0008832). The entire disclosures of these listed patents and patent applications are incorporated by reference herein. Other examples include processing with eddy current technology and magnetic-based ferrous metal separators, such as by equipment available from SGM Magnetics Corporation.

The heavy fraction processor 470 produces a metal concentrate product and a waste shredder residue product. The metal concentrate product produced by the heavy fraction processor 470 is transferred to the concentrated metal container 460. The waste shredder residue product produced by the heavy fraction processor 470 may be transferred to the screens 440 to be segregated by size as described with respect to FIG. 2. The screens 440 may have different sizes as described above with respect to step 250 to segregate the waste shredder residue product by size into different size ranges.

The segregated material (i.e., segregated heavy fraction or segregated waste shredder residue product) produced by the screen 440 is introduced into one or more destoner 450. In some example embodiments, the one or more destoners 450 include multiple destoners that are arranged in parallel or in series. For example, as described with respect to step 160 of FIGS. 1 and 3 and step 260 of FIG. 2, each size range of the segregated material may be sent to a separate destoner to be processed in parallel. Alternatively, each size range of material may be sent batch-wise to the same destoner. In yet another alternative embodiment, the segregated material with a size of 6 mm or less (or 3.5 mm or less) is processed in the one or more destoners 450 at step 160, 260 while larger material is not processed by the one or more destoners 450. Instead, the larger material may be processed with other equipment or size-reduced and reintroduced into the screens 440.

In some example embodiments, heavy fraction produced by the destoner 450 may be transferred to the container 460. The metal concentration in the material in the container 460 is approximately 2 to 7 times greater than the metal concentration in the low grade shredder residue in the source of low grade shredder residue 410. Material may be transported from one destoner to a second destoner or to and from screens using a conveyer system or other known technique for moving dry material.

One of ordinary skill in the art would appreciate that the present invention provides systems and methods for processing low metal grade fines materials to recover valuable metals, such as iron, aluminum, and copper, from the materials. The systems and methods employ processes that further refine the materials to concentrate the metallic material either after the materials are initially processed or as a first concentration process.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A method for recovering metal from low grade shredder residue fines comprising the steps of:
receiving a material comprising low grade shredder residue fines, wherein the low grade shredder residue fines comprises virgin shredder residue fines or waste shredder residue fines;
processing the received material in a first destoner to produce a first heavy fraction and a first light fraction of the material; and
collecting concentrated metals based on the first heavy fraction, wherein the concentrated metals has a concentration of metal constituents greater than the concentration of metal constituents in the received material.

2. The method of claim 1, further comprising the step of processing the first heavy fraction in a second destoner to produce a second heavy fraction and a second light fraction, wherein the second heavy fraction comprises a concentration of metal constituents greater than the concentration of metal constituents in the first heavy fraction.

3. The method of claim 1, further comprising the steps of:
segregating the first heavy fraction into at least a first size range and a second size range;
processing the first size range of the first heavy fraction in a second destoner; and
processing the second size range of the first heavy fraction in a third destoner.

4. The method of claim 3, wherein a third size range of the first heavy fraction is size-reduced for segregation into the first size range and the second size range.

5. The method of claim 1, wherein the concentrated metal is the same as the heavy fraction.

6. The method of claim 1, wherein the received material is dried in a dryer before processing the received material in the first destoner.

7. The method of claim 1, wherein the material is automobile shredder residue (ASR), whitegood shredder residue (WSR), or a combination of the ASR and the WSR.

8. A method for recovering metal from low grade shredder residue fines comprising the steps of:
receiving a material comprising low grade shredder residue fines;
drying the received material to produce a dried material;
processing the dried material in a first destoner to produce a first heavy fraction and a first light fraction of the material; and
collecting concentrated metals based on the first heavy fraction, wherein the concentrated metals has a concentration of metal constituents greater than the concentration of metal constituents in the received material.

9. The method of claim 8, wherein the low grade shredder residue fines comprises virgin shredder residue fines or waste shredder residue fines.

10. The method of claim 9, wherein the material is automobile shredder residue (ASR), whitegood shredder residue (WSR), or a combination of the ASR and the WSR.

11. The method of claim 8, further comprising, when the low grade shredder residue fines comprises virgin shredder residue fines, the step of processing the first heavy fraction into a metal concentrate product and waste shredder residue fines.

12. The method of claim 11, further comprising the steps of:
segregating the waste shredder residue fines into at least a first size range and a second size range; and
processing the first size range of the waste shredder residue fines and the second size range of the waste shredder residue fines in a second destoner to produce a second heavy fraction and a second light fraction.

13. The method of claim 8, further comprising the step of processing the first heavy fraction in a second destoner to produce a second heavy fraction and a second light fraction, wherein the second heavy fraction comprises a concentration of metal constituents greater than the concentration of metal constituents in the first heavy fraction.

14. A system for recovering metal from low grade shredder residue fines, the system comprising:
a dryer to produce a dried material from a received material by reducing moisture content of the received material, the received material comprising low grade shredder residue fines, wherein the low grade shredder residue fines comprises virgin shredder residue fines or waste shredder residue fines;
a first destoner to produce a first heavy fraction and a first light fraction of the dried material such that the heavy fraction comprises ferrous and non-ferrous metals; and
a screen to segregate the first heavy fraction by size into multiple size ranges of the first heavy fraction.

15. The system of claim 14, further comprising a second destoner to process the multiple size ranges of the first heavy fraction to produce a second heavy fraction and a second light fraction such that the second heavy fraction comprises a concentration of metal constituents greater than the concentration of metal constituents in the first heavy fraction.

16. The system of claim 14, wherein the material is automobile shredder residue (ASR), whitegood shredder residue (WSR), or a combination of the ASR and the WSR.

17. The system of claim 14, wherein the second destoner comprises multiple destoners that are arranged in parallel.

18. The system of claim 14, wherein the second destoner comprises multiple destoners that are arranged in series such that a output of a first destoner of the multiple destoners provided to a second destoner of the multiple destoners.
